(19) United States
(12) Patent Application Publication
(10) Pub. No.: US 2025/0111757 A1
(43) Pub. Date: Apr. 3, 2025

(54) CHIP PUSHER WITH CHIP DETECTION FOR LOCAL AND REMOTE GAMEPLAY

(71) Applicant: Amuse d.o.o., Ljubljana (SI)

(72) Inventors: John Joseph CONNELLY, Las Vegas, NV (US); Keiichi KOJIMA, Setagaya (JP); Satoshi JOKO, Sagamihara (JP); Katsuhiro KIDO, Ichihara (JP); Katsuhiro MIZUTANI, Shinagawa (JP)

(21) Appl. No.: 18/896,761

(22) Filed: Sep. 25, 2024

Related U.S. Application Data
(60) Provisional application No. 63/587,051, filed on Sep. 29, 2023.

(51) Int. Cl. G07F 17/32

(52) U.S. Cl. CPC G07F 17/3297; G07F 17/3237; G07F 17/3241; G07F 17/3248

(57) ABSTRACT

The present disclosure relates to systems and methods for gaming related to chip pusher apparatuses. Various embodiments may include identifying, by a sensor, a characteristic of a gaming chip received at a chip pusher apparatus, determining whether the gaming chip is valid to initiate a round of play, initiating a round of play, determining a value of any gaming chips received during the round of play, and updating a player account. Additional embodiments may enable remote operation and gameplay. In an example, systems and methods may include receiving information indicative of a remote wager for a round of play, initiating the round of play, resolving the wager, and updating a player account associated with the wager.

### CROSS REFERENCE TO RELATED APPLICATIONS

This application claims benefit under 35 U.S.C. § 119(e) of Provisional U.S. Patent Application No. 63/587,051, filed Sep. 29, 2023, the contents of which is incorporated herein by reference in its entirety.

### TECHNICAL FIELD

The present disclosure relates generally, but not exclusively, to the field of gaming apparatuses and methods for using the same.

### BACKGROUND INFORMATION

Casinos and other gaming establishments offer a variety of games to attract players for entertainment. Such games may include live table games (e.g., roulette, craps, blackjack, etc.), virtual games, physical machines (e.g., slot-like machines), individual player machines, stadium-style group stations, and various gameplay combinations.

A coin pusher machine is a casino game where a moving element, such as a pusher, moves back and forth along the back end of a platform. The platform contains a number of coins that are piled upon one another at the front end of the platform. If the pusher contacts any of the coins, that might cause that coin to push one or more other coins off an edge of the front end of the platform. Sometimes the pusher may contact a coin but not cause any coins to fall off the edge. If coins do fall off the edge fall, they fall into a trench from which the coins may be collected by a player. At some point, the coins on the platform and the pusher reach an equilibrium point where the pusher no longer contacts any of the coins, which is where the game comes in.

For the price of a coin, a player can insert the coin into a slot somewhere above the platform and the coin will drop onto the coin-filled platform. When the coin drops onto the platform, the new coin adds to and disturbs other coins on the platform which may cause the pusher to push other coins off the edge, which can then be collected by the player. If more coins get pushed off the edge than were dropped in by the player, the player wins. However, it is possible that the player may pay to drop a number of coins on the platform only to have no coins drop off the edge, or fewer coins than the player paid to play.

Traditionally, coin pusher players must physically go to a casino or a gaming location, and obtain physical coins (e.g., quarters or dollars) in order to play the game. However, playing at a casino may not always be possible, and obtaining enough coins to play may be difficult. When players are unable to play at a casino or obtain a desired number of coins, the casino does not receive the business and the player misses out on the gaming experience.

Additionally, players have many game types, options, and platforms available. Casinos and gaming providers must continuously innovate to attract and retain players, maintain profitability, and improve player experience.

### SUMMARY

Aspects of the present disclosure include systems, and methods for operating a chip pusher gaming apparatus. In an embodiment, a method may include receiving information indicative of a wager, which may be remote, for a round of play at the chip pusher gaming apparatus, initiating the round of play based on the wager, resolving the wager by determining a value of any gaming chips received during the round of play, and updating the player account based on the resolved wager. The remote wager may be associated with a player account, and initiating the round of play may include providing a gaming chip on a platform of the chip pusher gaming apparatus. The platform may include a plurality of gaming chips, and a pusher drives the plurality of gaming chips towards an edge of the platform.

According to some examples, the method may further provide a real-time video stream of the chip pusher gaming apparatus on a user interface associated with a remote computing device. The remote computing device may be at least one of a mobile computing device and a player station. In some examples, initiating the round of play includes automatically transferring the gaming chip from a storage area associated with the gaming apparatus to the platform. A conveyor may automatically transfer at least one gaming chip in the collection area to the storage area.

Accordingly to another example, a gaming system may include a computing device comprising a processor and a memory comprising instructions, which when executed by the processor cause the computing device to at least: identify, by a sensor, a characteristic of a gaming chip received at a chip pusher gaming apparatus, determine, based on the characteristic, whether the gaming chip is valid to initiate a round of play, and when the gaming chip is determined to be valid, initiate the round of play at the chip pusher gaming apparatus, determine a value of any gaming chips received, during the round of play, and update a player account based on the value.

The characteristic may include at least one of: a visual characteristic, a physical characteristic, an electronic characteristic, and a value associated with the gaming chip. The visual characteristic may include at least one of: an edge spot on the gaming chip, artwork on the gaming chip, at least one color on the gaming chip, and an ultraviolet fluorescence. The physical characteristic may include at least one of a gaming chip weight, and a shape of the gaming chip. The electronic characteristic may be associated with a Radio-Frequency Identification (RFID) tag. The sensor may include at least one of: a weight sensor, an RFID sensor, an ultraviolet detection sensor, an image sensor, and a shape detection sensor.

A chip pusher gaming apparatus may include a platform holding a plurality of gaming chips, a pusher driving the plurality of gaming chips towards a ledge or an edge, a sensor to identify a characteristic of a first gaming chip, and a value associated with the first gaming chip, a path to receive the first gaming chip and provide the first gaming chip on the platform, and a collection area to collect any gaming chips driven off the ledge by the pusher. Other features may include a gaming chip slot for manually receiving the first gaming chip and positioning the first gaming chip to be identified by the sensor, and a conveyor returning at least one gaming chip in the collection area to the storage area.

These and other features will be more clearly understood from the following detailed description taken in conjunction with the accompanying drawings and claims. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is perspective view of a chip pusher gaming apparatus in accordance with an embodiment.

FIG. 2 is perspective view of a platform of a chip pusher gaming apparatus further illustrating a pusher, the gaming chips on the platform, and an edge of the platform in accordance with an embodiment.

FIG. 3 includes top views of different types and denominations of gaming chips for use in a chip pusher gaming apparatus in accordance with an embodiment.

FIG. 4 is an exploded perspective view of a gaming chip with an RFID chip in accordance with an embodiment.

FIG. 5 is a top view of a mobile computing device illustrating remote gameplay of a chip pusher gaming apparatus in accordance with an embodiment.

FIG. 6 is a top view of a player standing before a play station that enables remote gameplay of a chip pusher gaming apparatus in accordance with an embodiment.

FIG. 7 provides a top, front and side view of a single player chip pusher gaming apparatus in accordance with an embodiment.

FIG. 8 is a more detailed side view of the chip pusher gaming apparatus of FIG. 7 further illustrating a shock absorber in accordance with an embodiment.

FIG. 9 is front and top view of a multiplayer chip pusher gaming apparatus in accordance with an embodiment.

FIG. 10 is an illustration of a security feature of a chip pusher gaming apparatus in accordance with an embodiment.

FIG. 11 is a flowchart providing an example of remote gameplay in accordance with an embodiment.

FIG. 12 is a flowchart providing an example of chip identification and gameplay in accordance with an embodiment.

FIG. 13 is an illustration of an exemplary block diagram representing a general-purpose computer system in which aspects of the methods and systems disclosed herein or portions thereof may be incorporated.

### DETAILED DESCRIPTION OF EMBODIMENTS

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

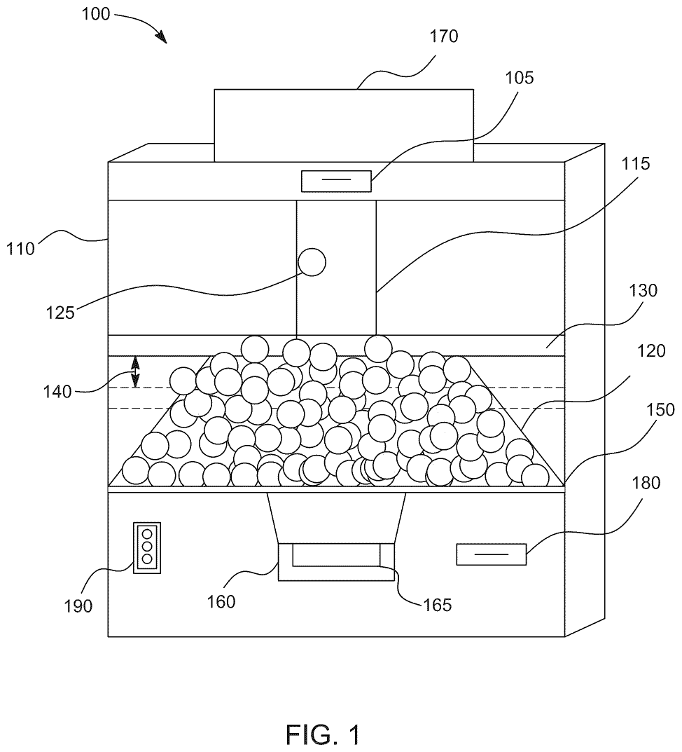

FIG. 1 illustrates an example chip pusher machine 100. The chip pusher machine may include a cabinet 110 containing electrical and mechanical components for operating and playing the game. The chip pusher machine 100 may include a horizontal or substantially horizontal platform 120 containing a plurality of chips 125. The chips may be a type of a gaming chip (e.g., a casino chip) or another object (e.g., a plastic or metal disk, etc.).

A chip 125 may drop into chute 115 and land on platform 120. In some examples, a player may manually drop a chip into a slot 105 on the front of the cabinet 110 to initiate a round of play. In other examples, such as during remote gameplay, a chip held in a storage container 170 may be automatically dropped into chute 115 when the game is initiated.

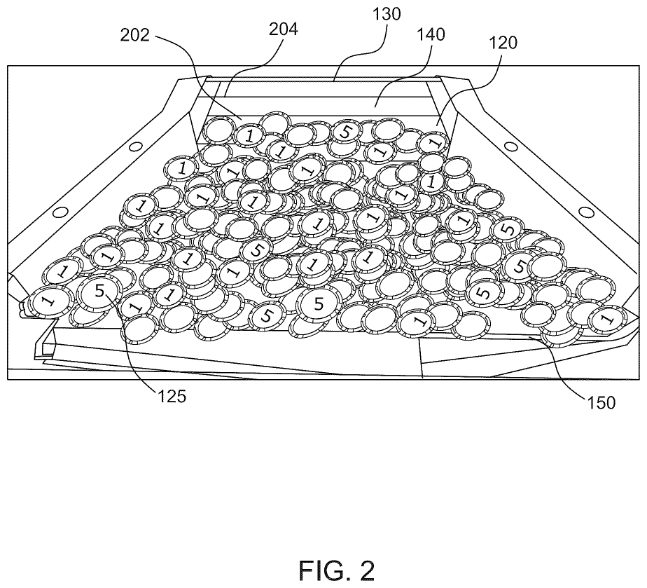

A pusher 130 may include at least one movable element, such as a pusher arm driving the plurality of chips, including the dropped chip, toward a ledge 150. The pusher 130 may continuously move between a first position and second position (see, e.g., path 140) to drive the plurality of chips 125 toward the ledge 150. A motor (not shown) housed within the cabinet 110 may drive the movement of the pusher 130. In some examples, the pusher 130 includes a stationary arm or ledge, and the platform moves along the path 140 between the first position and the second position. FIG. 2 provides another example of the chips 125 on the platform 120 between the second position 202 and the ledge 150. The pusher 130 is shown at first position 204, with the path 140 between the first position 204 and the second position 202.

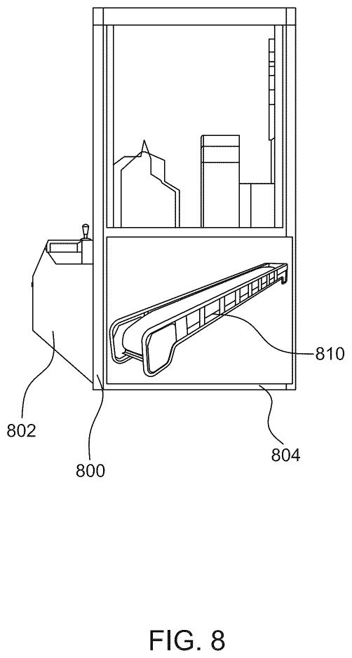

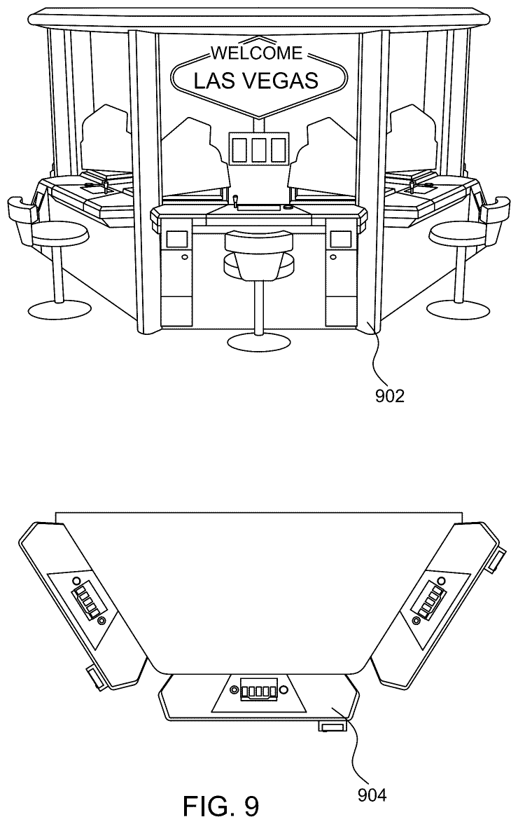

Chips pushed over the ledge 150 may fall into a collection area 160. In some examples, the collection area includes a guard 165, which may serve as a security measure to prevent objects and players from reaching into the cabinet 110 and attempting to collect chips from the platform. In some examples, the guard 165 may move between an open position and a closed position to direct where fallen chips land. In an open position, chips entering the collection area 160 may be directed toward an opening of the cabinet to allow players to collect the earned chips. The open position may be provided during a round of play. The closed position may be a default position. In an example, the closed position may cause the guard to block the cabinet opening and cause any fallen chips to be directed to a storage container 170. The guard 165 may remain in the closed position until a game or a round of play begins. The start of a game or round of play may cause the guard to switch to an open position during the game and revert back to the closed position after the round or game ends. A conveyor system 810 further illustrated in FIG. 8 may transport any fallen chips from the collection area 160 to the storage container 170. While the positioning and size of the conveyor system 810 depicted in FIG. 8 does not accurately reflect where the conveyor system 810 would actually be located, it illustrates the point that traditional coin pusher machines use a coin rail to circulate coins within the machine. The coin rails are made from metal, as are the coins, so this type of recirculation system works fine in that environment, but chips do not have the same hardness as coins so a coin rail would wear the chips much faster. Accordingly, the chip pusher machine 100 uses a conveyor to move the chips from the collection area to the storage area, thereby saving the chips from wearing as quickly.

A chip pusher machine 100 may include at least one sensor system 190 for determining a characteristic of the chip. The characteristic may, for example, serve as a security measure, to ensure that a proper chip is being played with the machine. The sensor system 190 may help to prevent damage or an otherwise inappropriate use of the chip pusher machine.

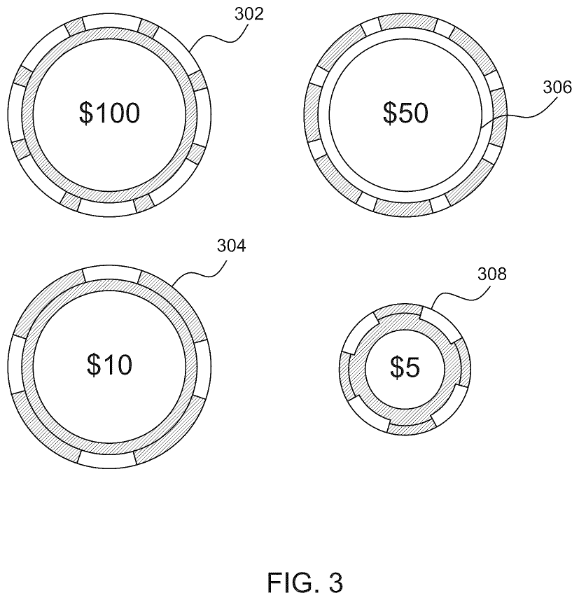

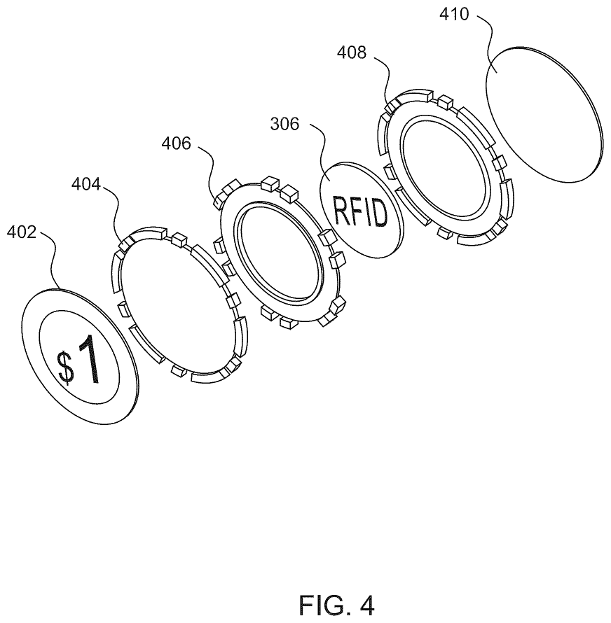

In various examples, as discussed herein, a gaming chip-such as a casino gaming chip—may be used as the chip in the chip pusher machine. FIG. 3 illustrates different examples of gaming chips, which may be usable in embodiments discussed herein. Gaming chips may have different designs and artwork to distinguish the chip, for example, from chips used at other casinos, other gaming locations, and other chip types. Chips may have distinguishing edge spots 302, text, symbols, currency value (e.g., $5, $10, $50, $100, etc.), weights, sizes (see, e.g., chip 308), and other features such as a Radio-Frequency Identification (RFID) Tag (as further discussed in reference to FIG. 4), or an Ultra-Violet (UV) detectable coloring 220.

The sensor system 190 may identify a characteristic of the gaming chip, e.g., to identify at least one of a physical characteristic, a visual characteristic, and an electronic characteristic of the gaming chip. Since many casinos use chips having a similar size and weight, a sensor system 190 identifying a characteristic of the chip may help identify a type of gaming chip and ensure that a proper gaming chip is being used with the machine 100. In some examples, the sensor system 190 may further identify a value of the gaming chip. The value of the gaming chip may be relevant for different gaming modes, game types, and wagers.

In some examples, the sensor system 190 may identify a physical characteristic including at least one of a weight of the gaming chip, and a shape of the gaming chip. In an example, a gaming chip that is an incorrect size (e.g., too large or too small) may be prevented from being delivered to the platform 120. Referring to FIG. 3, in an example where a chip pusher machine is set to manually accept chips of a certain size (e.g., the $10, $50, or $100 chip size), insertion of a physically smaller $5 chip may be rejected. The $5 chip may, for example, be delivered directly to a collection area rather than through the chute 115 to the platform 120. Similarly, different value chips may have different weights. A weight sensor may be set to verify whether a chip is a certain weight or within a certain weight range and reject any chips that do not satisfy the weight setting for the chip pusher machine.

A visual characteristic may include an edge spot design on the gaming chip (see, e.g., edge spot 302), artwork on the gaming chip, at least one color on the gaming chip, and an ultraviolet fluorescence (see, e.g., UV coloring 304). The sensor system 190 may verify a chip type or a chip value based on one or more unique visual characteristics associated with the gaming chip.

As further illustrated in FIG. 4, an electronic characteristic may include information detected from and associated with a Radio-Frequency Identification (RFID) tag (see, e.g., RFID tag 306). The chip 125 may include front artwork, 402, a front weight 404 that also contributes to an edge spot, a color denomination 406 that also contributes to an edge spot, the RFID chip 306, a back weight 408 that also contributes to an edge spot, and back artwork 410. The front and back artwork may indicate the denomination, the issuer of the chip, and other features. The sensor system 190 may verify a chip type based on an RFID tag 306 on or within the chip. The RFID tag may, for example, provide information relating to at least one of a value of the chip, a type of chip, and a gaming history associated with the chip. The unique ID of each RFID tag also makes it possible to identify how many chips are currently in the machine, in storage container, on the platform, and/or in the collection area.

While the sensor system 190 is illustrated in FIG. 1 in a lower portion of the cabinet 110, it may be located anywhere and in multiple locations throughout the chip pusher machine 100 and may include multiple components or sensors, including one or more of a weight sensor, an RFID sensor, an ultraviolet detection sensor, an image sensor, and a shape detection sensor. In various examples, the sensor system 190 may identify the characteristic of the gaming chip before it drops into chute 115. In various examples, the sensor system 190 may identify the characteristic after a gaming chip is received at slot 105, or as the gaming chip is being delivered from the storage container 190.

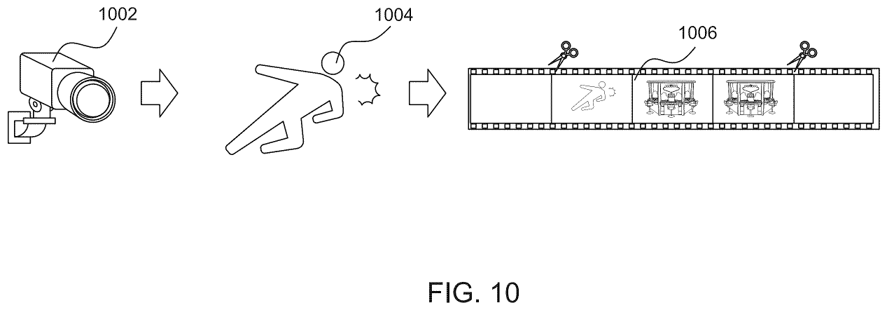

In additional examples, sensor system 190 may include a tilt detection sensor 800 mounted between a control panel 802 and a main unit 804 of the chip pusher machine to monitor an orientation of the cabinet 110, as illustrated in FIG. 8. The tilt detection sensor 800 may be located anywhere in the cabinet 110 or in multiple places throughout the cabinet 110 such that it is triggered when the cabinet is tilted, hit, bumped, or shaken. The tilt detection sensor 800 may initiate an alarm (e.g., a visual alarm, auditory alarm, a combination of alarm types, etc.) or other notification to be broadcast or sent (e.g., to another computing device) with information about the alarm event as further illustrated in FIG. 10. The tilt detection sensor 800 may also cause the game to automatically stop or shutdown. The guard 165 may switch to or lock into the closed position during an alarm event. The chip pusher machine 100 may need to be reset after an alarm event. Other security measure may also be implemented when an alarm occurs. For example, in FIG. 10, a camera 1002, either mounted in the chip pusher machine or within the environment of the chip pusher machine, may continuously monitor activity around the chip pusher machine and store at least some of the resulting video. When an alarm event occurs because a person 1004 has tilted, bit, bumped or shaken the chip pusher machine, video 1006 of activity around the chip pusher machine just before and after the alarm event so that an operator can review the clips of the video and determine if the person 1004 attempted to cheat and initiate appropriate action.

Various gameplay modes may utilize different types of chips (e.g., casino gaming chips), prize modalities (e.g., virtual currency), locations of play (e.g., local play, remote play), security features (e.g., sensor system 190), and chip drop events (e.g., automatic, player-initiated). Any of a combination of game mode features may be combined to provide a customized gameplay experience.

In a first example, a player manually inserts a chip 125 into the slot 105, where it slides down the chute 115 onto the platform 120, with any resulting collected chips being pushed off the platform 120 into the collection area 160.

In a second example, a player may associate a player account with the round of play. For example, a player may insert a player card or other identification or credential into a card slot 180, as shown in FIG. 1, to connect a player account with the game. The player may then manually insert a chip 125 into slot 105, where it slides down the chute 115 onto the platform 120, with any resulting collected chips being automatically associated with and added to the player account. Such a gameplay mode eliminates a need for a player to retrieve, count, or carry a large number of chips from the collection area 160. One or more sensors within the collection area 160 may automatically identify a number and/or a type of chip falling from the ledge 150 into the collection area. This automatic counting process may expedite gameplay and enable more rounds of play to occur than a traditional collection method.

In a third example, a player may associate a player account to initiate a round of play, and a chip is delivered from the storage container 170 through the chute 115 onto the platform 120. In this example, a player would not need to manually insert a chip into slot 105. As such, a player may be able to play the chip pusher machine locally or remotely with the chips being inserted by the machine itself by removing the chip from storage and dropping it into the chute 115. Similar to the above example, any chips falling into the collection area 160 may be automatically counted and added to the player account.

In a fourth example, a player may switch between gameplay modes and/or features of different gameplay modes. For example, a player may choose to physically insert chips into slot 105, then switch to the automatic delivery of chips from the storage container 170. A player may also switch between collecting the chips from the collection area 160 and having any winnings automatically credited to their player account.

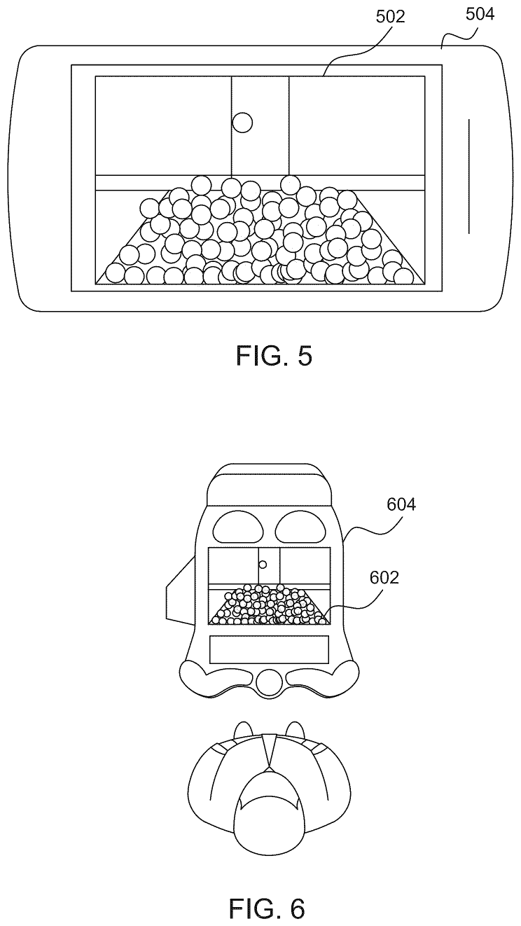

FIGS. 5-6 illustrate examples of remote gameplay modes that may be performed with the chip pusher machine 100, and any of the examples discussed herein. FIG. 5 illustrates a gameplay mode wherein a user plays the chip pusher machine 100 using a remote computing device 502. The remote computing device may be a smartphone, tablet, laptop, or other type of computing device that communicates with the chip pusher machine. Chips that actually fall into the collection area may be credited to the remote play electronically while the physical chips are transported back to the storage container. FIG. 6 illustrates a gameplay mode wherein a user plays the chip pusher machine 100 using a player station 602 in a manner similar to the remote computing device 502. The player station 404 may, for example, be provided within a gaming location, such as a casino.

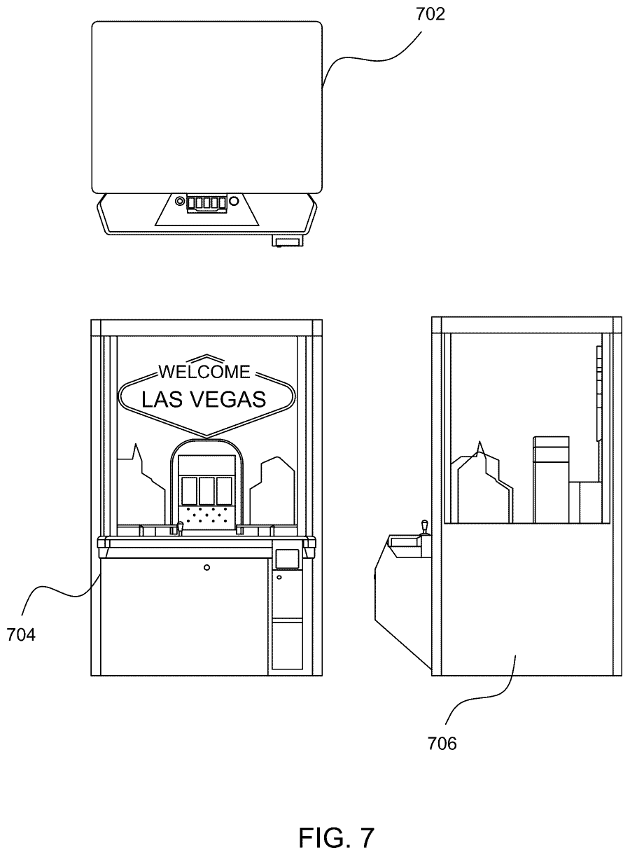

FIG. 7 provides a view of a chip pusher machine from a top view 702, a front view 704, and a side view 706. FIG. 8 provides a view of multiple player chip pusher machine from a front view 902 and a top view 904.

In the remote gameplay examples, a player may view at least a portion of the chip pusher machine on a display (e.g., displays 504, 604). For example, the platform 120, the plurality of chips 125, and the chute 115 may be visible on the display 504, 506. In various examples, the display provides a real-time, live video stream of the chip pusher machine. Remote players may initiate rounds of play in real-time and initiate and view live chip drops and gaming outcomes.

A player account may be associated with the remote gameplay, such that gaming events will credit and deduct, in real-time, in accordance with the gaming event occurring at the chip pusher machine. In some examples, a live operator may be present to perform one or more aspects of the chip pusher machine operation in accordance with instructions received via the remote computing device. In other examples, chip pusher machine operations are automated and may execute instructions received via the remote computing device without the need for an operator at the device.

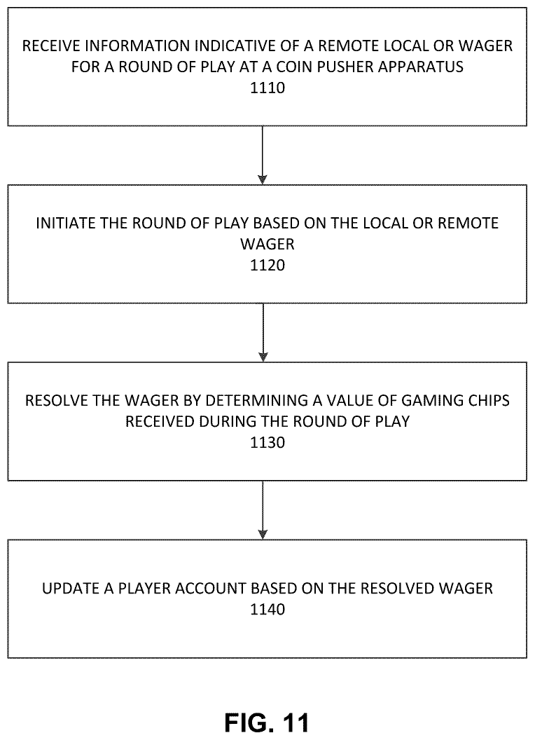

FIG. 11 illustrates an example flowchart relating to local or remote gameplay. At block 1110, aspects may receive information indicative of a local or remote wager for a round of play at a chip pusher machine.

At block 1120, aspects may initiate the round of play based on the local or remote wager. In some examples, initiating the round of play includes manually providing a chip on a platform of the chip pusher machine. Alternatively, the round of play may be initiated remotely, e.g., via a mobile computing device, player station, or other remote computing device. In such examples, the chip may be provided by the chip pusher machine itself. Initiating the round of play may require associating a player account with the round of play, for example, by logging into a player account, inserting a player card into the chip pusher machine, or another method.

At block 1130, aspects may resolve the wager by determining a value of gaming chips received during the round of play. Wager resolution may include a determination of a number and a value of chips received at a collection area during the round of play, or after the gaming chip is delivered to the platform. In some examples, the value of the gaming chips may be limited to gaming chips received within a certain time period (e.g., 5, 10, 15 seconds) after the gaming chip is delivered to the platform. In other examples, the timer period may refer to a period of time after which a last chip has been received in the collection area. Different timing periods may be implemented, for example, to keep games running timely and efficiently.

At block 1140, aspects may update a player account based on the resolved wager. A player account associated with the round of play may be credited a value associated with any chips received at the collection area. If no chips were collected at the collection area, the player account may be deducted a value associated with the one or more chips delivered to the platform.

In some examples, a chip pusher machine may automatically transfer one or more gaming chips received at the collection area back to the storage area. The transfer may occur, for example, after a round of play has ended.

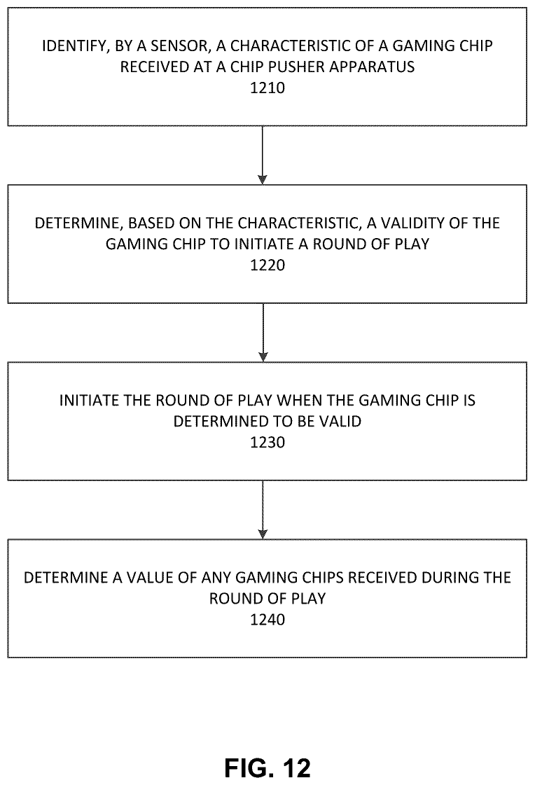

FIG. 12 illustrates an example flowchart relating to chip identification and gameplay, in accordance with an embodiment. At block 1210, aspects may identify, by a sensor, a characteristic of a gaming chip received at a chip pusher apparatus. As discussed herein, the sensor may include one or more of a weight sensor, an RFID sensor, an ultraviolet detection sensor, an image sensor, and a shape detection sensor. The sensor may be positioned to identify a gaming chip prior to its delivery to the platform. The sensor may, for example, be positioned along a path between a slot to receive the gaming chip and the chute. In examples where the gaming chip comes from the storage container, the sensor may be positioned on or around the storage container. The sensor may identify the gaming chip as it exits the storage container, or otherwise prior to delivery to the chute and the platform.

The characteristic of the gaming chip may be a physical characteristic including at least one of a gaming chip weight, and a shape of the gaming chip. The characteristic may also be a visual characteristic including at least one of: an edge spot on the gaming chip, artwork on the gaming chip, at least one color on the gaming chip, and an ultraviolet fluorescence. The characteristic may also be an electronic characteristic, such as information associated with a Radio-Frequency Identification (RFID) tag.

At block 1220, aspects may determine, based on the characteristic, a validity of the gaming chip to initiate a round of play. A chip pusher machine may accept gaming chips having one or more characteristics and reject gaming chips without the one or more characteristics. Accepted chips may be delivered to the platform, whereas rejected chips may be transferred to a separate storage area or rejection container.

In some examples, chips having an improper size characteristic may not be able to enter the chip slot on the chip pusher machine. In other examples, an improperly sized chip, such as a chip that is too small, may be diverted to a different path and not delivered to the chute leading to the platform. Chip acceptance or rejection may be a binary decision based on whether the sensor has identified the one or more required characteristics associated with proper chips. In various examples, the determination may occur in real-time, or otherwise such that a player does not notice a lag or significant delay after inserting a chip or initiating a chip drop.

At block 1230, aspects may initiate the round of play when the gaming chip is determined to be valid. After the gaming chip is determined to be valid, the round of play may be initiated by delivering a chip to the platform.

At block 1240, aspects may determine a value of any gaming chips received during the round of play. One or more sensors may automatically determine a value of gaming chips. The gaming chips received during the round of play may refer to any chips received in the collection area for a period of time after a gaming chip has been delivered to the platform.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The techniques described above can be implemented on a computing device associated with a gaming device (e.g., a player station operating one or more games, a mobile computing device, such as a smartphone, a laptop, or a tablet), a plurality of computing devices associated with a plurality of gaming devices, a controller in communication with the gaming device(s) (e.g., a controller configured to synchronize the gaming devices(s)), or a plurality of controllers in communication with the gaming device(s). Additionally, the techniques may be distributed between the computing device(s) and the controller(s).

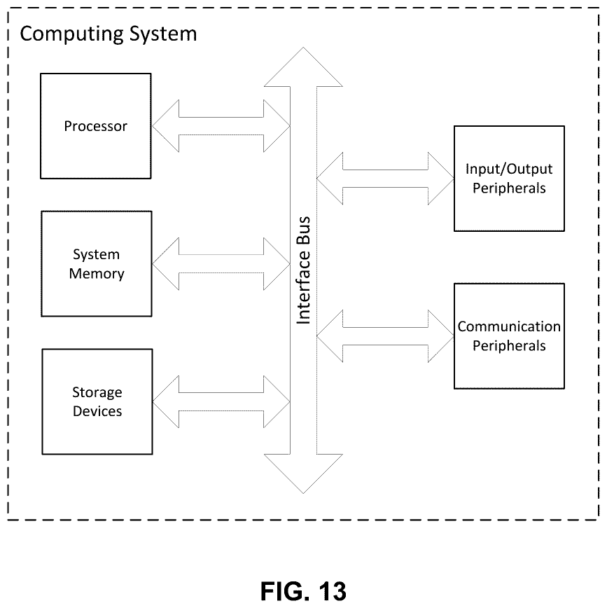

FIG. 13 illustrates an exemplary block diagram of a computing system that includes hardware modules, software module, and a combination thereof and that can be implemented as the computing device and/or as the server.

In a basic configuration, the computing system may include at least a processor, a system memory, a storage device, input/output peripherals, communication peripherals, and an interface bus. Instructions stored in the memory may be executed by the processor to perform a variety of methods and operations, including the roulette wheel velocity adjustments and result detection optimization, as described above. The computing system components may be present in the gaming device, in a server or other component of a network, or distributed between some combinations of such devices.

The interface bus is configured to communicate, transmit, and transfer data, controls, and commands between the various components of the electronic device. The system memory and the storage device comprise computer readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

The system memory and the storage device may also comprise computer readable signal media. A computer readable signal medium may include a propagated data signal with computer readable program code embodied therein. Such a propagated signal may take any of variety of forms including, but not limited to, electro-magnetic, optical, or any combination thereof. A computer readable signal medium may be any computer readable medium that is not a computer readable storage medium and that can communicate, propagate, or transport a program for use in connection with the computing system.

Further, the input and output peripherals include user interfaces such as a keyboard, screen, microphone, speaker, other input/output devices, and computing components such as digital-to-analog and analog-to-digital converters, graphical processing units, serial ports, parallel ports, and universal serial bus. The input/output peripherals may also include a variety of sensors, such as light, proximity, GPS, magnetic field, altitude, and velocity/acceleration. RSSI, and distance sensors, as well as other types of sensors. The input/output peripherals may be connected to the processor through any of the ports coupled to the interface bus.

The user interfaces can be configured to allow a user of the computing system to interact with the computing system. For example, the computing system may include instructions that, when executed, cause the computing system to generate a user interface and carry out other methods and operations that the user can use to provide input to the computing system and to receive an output from the computing system.

This user interface may be in the form of a graphical user interface that is rendered at the screen and that is coupled with audio transmitted on the speaker and microphone and input received at the keyboard. In an embodiment, the user interface can be locally generated at the computing system. In another embodiment, the user interface may be hosted on a remote computing system and rendered at the computing system. For example, the server may generate the user interface and may transmit information related thereto to the computing device that, in turn, renders the user interface to the user. The computing device may, for example, execute a browser or an application that exposes an application program interface (API) at the server to access the user interface hosted on the server.

Finally, the communication peripherals of the computing system are configured to facilitate communication between the computing system and other computing systems (e.g., between the computing device and the server) over a communications network. The communication peripherals include, for example, a network interface controller, modem, various modulators/demodulators and encoders/decoders, wireless and wired interface cards, antenna, and the like.

The communication network includes a network of any type that is suitable for providing communications between the computing device and the server and may comprise a combination of discrete networks which may use different technologies. For example, the communications network includes a cellular network, a Wi-Fi/broadband network, a local area network (LAN), a wide area network (WAN), a telephony network, a fiber-optic network, or combinations thereof. In an example embodiment, the communication network includes the Internet and any networks adapted to communicate with the Internet. The communications network may be also configured as a means for transmitting data between the computing device and the server.

The techniques described above may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile, or non-volatile storage.

In an embodiment, a method for operating a chip pusher gaming apparatus, the method comprising: receiving information indicative of a remote wager for a round of play at the chip pusher gaming apparatus, wherein the remote wager is associated with a player account; initiating the round of play based on the remote wager, wherein initiating the round of play comprises providing a gaming chip on a platform of the chip pusher gaming apparatus, wherein the platform comprising a plurality of gaming chips, and wherein the chip pusher gaming apparatus comprises a pusher driving the plurality of gaming chips towards a ledge of the platform; resolving the wager by determining a value of any gaming chips received, during the round of play, in a collection area beneath the ledge; and updating the player account based on the resolved wager.

In an embodiment, further comprising: providing, at least during the round of play, a real-time video stream of the chip pusher gaming apparatus on a user interface associated with a remote computing device.

In an embodiment, wherein the remote computing device is at least one of a mobile computing device and a player station.

In an embodiment, wherein initiating the round of play comprises automatically transferring the gaming chip from a storage area associated with the gaming apparatus to the platform.

In an embodiment, further comprising: automatically transferring at least one gaming chip in the collection area to the storage area.

In an embodiment, wherein the storage area and the collection area are housed within a cabinet associated with chip pusher gaming apparatus.

In an embodiment, a gaming system, comprising: a computing device comprising a processor and a memory comprising instructions, which when executed by the processor cause the computing device to at least: identify, by a sensor, a characteristic of a gaming chip received at a chip pusher gaming apparatus, determine, based on the characteristic, whether the gaming chip is valid to initiate a round of play; when the gaming chip is determined to be valid, initiate the round of play at the chip pusher gaming apparatus, wherein the instructions to initiate the round of play comprises providing the gaming chip on a platform of the chip pusher gaming apparatus, wherein the platform comprising a plurality of gaming chips, and wherein the chip pusher gaming apparatus comprises a pusher driving the plurality of gaming chips towards a ledge of the platform; determine a value of any gaming chips received, during the round of play, in a collection area beneath the ledge; and update a player account based on the value.

In an embodiment, wherein the characteristic is at least one of: a physical characteristic, a visual characteristic, an electronic characteristic, and a value associated with the gaming chip.

In an embodiment, wherein the visual characteristic includes at least one of: an edge spot on the gaming chip, artwork on the gaming chip, at least one color on the gaming chip, and an ultraviolet fluorescence.

In an embodiment, wherein the physical characteristic includes at least one of a gaming chip weight, and a shape of the gaming chip.

In an embodiment, wherein the electronic characteristic is associated with a Radio-Frequency Identification (RFID) tag.

In an embodiment, wherein the sensor comprises at least one of: a weight sensor, an RFID sensor, an ultraviolet detection sensor, an image sensor, and a shape detection sensor.

In an embodiment, wherein when the characteristic indicates that the gaming chip is not valid, transfer the gaming chip to a chip storage area.

In an embodiment, a chip pusher gaming apparatus, comprising: a platform holding a plurality of gaming chips; a pusher driving the plurality of gaming chips towards a ledge, wherein the pusher moves between a first position and a second position on the platform; a sensor to identify a characteristic of a first gaming chip, and a value associated with the first gaming chip; a path to receive the first gaming chip and provide the first gaming chip on the platform; and a collection area to collect any gaming chips driven off the ledge by the pusher.

In an embodiment, further comprising: a gaming chip slot for receiving the first gaming chip and positioning the first gaming chip to be identified by the sensor.

In an embodiment, further comprising a computing device configured to at least: receive, from a remote computing device, a wager to initiate a round of play, wherein the wager is associated with a player account; initiate the round of play by transferring the first gaming chip from a storage area to the path; resolving the wager by determining a value of any gaming chips received in the collection area during the round of play, in a collection area beneath the ledge; and updating the player account based on the resolved wager.

In an embodiment, further comprising: a conveyor returning at least one gaming chip in the collection area to the storage area.

In an embodiment, wherein the computing device is further configured to provide, at least during the round of play, a real-time video stream of the platform on a user interface associated with the remote computing device.

In an embodiment, wherein the platform, the pusher, the sensor, the path, and the collection area are housed within a cabinet, and wherein a tilt detection sensor is configured trigger an alarm and a prevent a round of play when the cabinet is tilted.

In an embodiment, wherein the characteristic is at least one of: an edge spot on the gaming chip, artwork on the gaming chip, at least one color on the gaming chip, a weight of the gaming chip, a shape of the chip, an ultraviolet fluorescence, and a Radio-Frequency Identification (RFID) tag.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terms and descriptions used above are set forth by way of illustration only and are not meant as limitations. Those skilled in the art will recognize that those and many other variations, enhancements and modifications of the concepts described herein are possible without departing from the underlying principles of the invention. The scope of the invention should therefore be determined only by the following claims and their equivalents.

What is claimed is:

1. A method for operating a chip pusher gaming apparatus, the method comprising:
receiving information indicative of a wager for a round of play at the chip pusher gaming apparatus, wherein the wager is associated with a player account;
initiating the round of play based on the wager, wherein initiating the round of play comprises providing a gaming chip on a platform of the chip pusher gaming apparatus, wherein the platform comprising a plurality of gaming chips, and wherein the chip pusher gaming apparatus comprises a pusher driving the plurality of gaming chips towards a ledge of the platform;
resolving the wager by determining a value of any gaming chips received, during the round of play, in a collection area beneath the ledge; and
updating the player account based on the resolved wager.

2. The method of claim 1, further comprising: providing, at least during the round of play, a real-time video stream of the chip pusher gaming apparatus on a user interface associated with a remote computing device through which the wager may be placed.

3. The method of claim 2, wherein the remote computing device is at least one of a mobile computing device and a player station.

4. The method of claim 1, wherein initiating the round of play comprises automatically transferring the gaming chip from a storage area associated with the gaming apparatus to the platform.

5. The method of claim 4, further comprising: automatically transferring via a conveyor at least one gaming chip in the collection area to the storage area.

6. The method of claim 5, wherein the storage area and the collection area are housed within a cabinet associated with chip pusher gaming apparatus.

7. A gaming system, comprising:
a computing device comprising a processor and a memory comprising instructions, which when executed by the processor cause the computing device to at least:
identify, by a sensor, a characteristic of a gaming chip received at a chip pusher gaming apparatus,
determine, based on the characteristic, whether the gaming chip is valid to initiate a round of play;
when the gaming chip is determined to be valid, initiate the round of play at the chip pusher gaming apparatus, wherein the instructions to initiate the round of play comprises providing the gaming chip on a platform of the chip pusher gaming apparatus, wherein the platform comprising a plurality of gaming chips, and wherein the chip pusher gaming apparatus comprises a pusher driving the plurality of gaming chips towards a ledge of the platform;
determine a value of any gaming chips received, during the round of play, in a collection area beneath the ledge; and
update a player account based on the value.

8. The gaming system of claim 7, wherein the characteristic is at least one of: a physical characteristic, a visual characteristic, an electronic characteristic, and a value associated with the gaming chip.

9. The gaming system of claim 8, wherein the visual characteristic includes at least one of: an edge spot on the gaming chip, artwork on the gaming chip, at least one color on the gaming chip, and one or more of a Radio-Frequency Identification (RFID) tag and an ultraviolet fluorescence.

10. The gaming system of claim 8, wherein the physical characteristic includes at least one of a gaming chip weight, and a shape of the gaming chip.

11. The gaming system of claim 8, wherein the electronic characteristic is associated with a Radio-Frequency Identification (RFID) tag.

12. The gaming system of claim 7, wherein the sensor comprises at least one of: a weight sensor, an RFID sensor, an ultraviolet detection sensor, an image sensor, and a shape detection sensor.

13. The gaming system of claim 7, wherein when the characteristic indicates that the gaming chip is not valid, transfer the gaming chip to a chip storage area.

14. A chip pusher gaming apparatus, comprising:
a platform holding a plurality of gaming chips;
a pusher driving the plurality of gaming chips towards a ledge, wherein the pusher moves between a first position and a second position on the platform;
a sensor to identify a characteristic of a first gaming chip, and a value associated with the first gaming chip;
a path to receive the first gaming chip and provide the first gaming chip on the platform; and
a collection area to collect any gaming chips driven off the ledge by the pusher.

15. The chip pusher apparatus of claim 14, further comprising a gaming chip slot for manually receiving the first gaming chip and positioning the first gaming chip to be identified by the sensor.

16. The chip pusher apparatus of claim 14, further comprising a computing device configured to at least:
receive, from a remote computing device, a wager to initiate a round of play, wherein the wager is associated with a player account;
initiate the round of play by transferring the first gaming chip from a storage area to the path;
resolving the wager by determining a value of any gaming chips received in the collection area during the round of play, in a collection area beneath the ledge; and
updating the player account based on the resolved wager.

17. The chip pusher apparatus of claim 16, further comprising: a conveyor returning at least one gaming chip in the collection area to the storage area.

18. The chip pusher apparatus of claim 16, wherein the computing device is further configured to provide, at least during the round of play, a real-time video stream of the platform on a user interface associated with the remote computing device.

19. The chip pusher apparatus of claim 14, wherein the platform, the pusher, the sensor, the path, and the collection area are housed within a cabinet, and wherein a tilt detection sensor is configured trigger an alarm and a prevent a round of play when the cabinet is tilted.

20. The chip pusher apparatus of claim 14, wherein the characteristic is at least one of: an edge spot on the gaming chip, artwork on the gaming chip, at least one color on the gaming chip, a weight of the gaming chip, a shape of the chip, an ultraviolet fluorescence, and a Radio-Frequency Identification (RFID) tag.
